(19) United States
(12) Patent Application Publication
(10) Pub. No.: US 2023/0181414 A1
(43) Pub. Date: Jun. 15, 2023

(54) Therapeutic Fluid Apparatuses And Methods Of Using The Same

(71) Applicants: Tracie Ragene Figueroa, Greensboro, NC (US); Stephanie Allyssa LoPresti, Greensboro, NC (US)

(72) Inventors: Tracie Ragene Figueroa, Greensboro, NC (US); Stephanie Allyssa LoPresti, Greensboro, NC (US)

(21) Appl. No.: 18/078,792

(22) Filed: Dec. 9, 2022

Related U.S. Application Data
(60) Provisional application No. 63/265,224, filed on Dec. 10, 2021.

(51) Int. Cl. A61H 9/00

(52) U.S. Cl. CPC A61H 9/0021; A61H 2009/0035; A61H 2009/0042

(57) ABSTRACT

Fluid therapy, for example including spray water at along a user's body, have been found to provide various advantages both as a medical therapeutic technique for treating various physical ailments as well as to improve comfort of a user generally. Embodiments provide therapeutic fluid apparatus(es) and methods of using said therapeutic fluid apparatus(es). One example therapeutic fluid apparatus includes fluid outlets at particular positions of the apparatus to enable spraying of a fluid drawn from the environment around the apparatus at particular points along a user. Some embodiment therapeutic fluid apparatus(es) are removable from the environment(s) from which they draw fluid for use, such that the therapeutic fluid apparatus(es) can be positioned within such environment(s) without permanently altering the environment and/or otherwise affixing the therapeutic fluid apparatus within the environment. Some such therapeutic fluid apparatus(es) are similarly constructed of lightweight materials to facilitate portability of the therapeutic fluid apparatus(es).

### CROSS REFERENCE TO RELATED APPLICATIONS

This application is a claims priority to U.S. Provisional Application No. 63/265,224, filed Dec. 10, 2021, the contents of which are incorporated herein by reference in their entirety.

### BACKGROUND

Water therapy that utilizes targeted pressurized spraying of water along particular body parts of a user has been identified as a particularly useful therapeutic for relieving symptoms of particular physical ailments of the user affected by such ailments. Units enabling such water therapy, however, often require specialized configuring of the environment in which the unit is to be used.

Inventors have discovered problems with current implementations of units for water and other fluid therapy. Through applied effort, ingenuity, and innovation, the inventors have solved many of these problems by developing the solutions embodied in the present disclosure, the details of which are described further herein.

### BRIEF SUMMARY

In one aspect, a therapeutic fluid apparatus includes a back portion and a seat portion, where the back portion includes a first at least one fluid outlet, at least one support connected to the seat portion, the at least one support includes a second at least one fluid outlet, at least one fluid pump fluidically coupled to the first at least one fluid outlet and the second at least one fluid outlet, where the at least one fluid pump is configured to direct at least a first portion of fluid to the first at least one fluid outlet and at least a second portion of fluid to the second at least one fluid outlets.

In some embodiments of the therapeutic fluid apparatus the fluid pump includes a battery configured to power to the fluid pump.

In some embodiments of the therapeutic fluid apparatus the fluid pump includes a toggle configured to activate the fluid pump.

In some embodiments of the therapeutic fluid apparatus the back portion includes at least a first spacer and a second spacer.

In some embodiments of the therapeutic fluid apparatus further includes a horizontal spacer connected to the back portion at a point where the back portion contacts the seat portion.

In some embodiments of the therapeutic fluid apparatus the first at least one fluid outlet includes a first plurality of fluid outlets.

In some embodiments of the therapeutic fluid apparatus the back portion includes at least one spacer that separates a first section of the back portion and a second section of the back portion, and where the first plurality of fluid outlets includes at least a first fluid outlet connected to the first section of the back portion and at least a second fluid outlet connected to the second section of the back portion.

In some embodiments of the therapeutic fluid apparatus the at least one support includes a plurality of supports.

In some embodiments of the therapeutic fluid apparatus the plurality of supports includes at least one rear support and at least one front support, where the at least one front support includes the first second at least one fluid outlet.

In some embodiments of the therapeutic fluid apparatus the plurality of supports includes at least one support connected to the seat portion between the at least one front support and the at least one rear support.

In some embodiments of the therapeutic fluid apparatus the plurality of supports includes at least a front left support and a front right support, where the front left support includes a first portion of the second at least one fluid outlets and where the front right support includes a second portion of the second at least one fluid outlets.

In some embodiments of the therapeutic fluid apparatus the front left support connected to the seat portion at a front left corner of the seat portion, and where the front right support is connected to the seat portion at a front right corner of the seat portion.

In some embodiments of the therapeutic fluid apparatus the seat portion includes at least one fluid drainage cavity.

In some embodiments of the therapeutic fluid apparatus the seat portion includes at least one arm rest moveably rotatable from a vertical orientation to a horizontal orientation.

In some embodiments of the therapeutic fluid apparatus the at least one pump includes a single pump fluidically coupled to each of the first at least one fluid outlet and each of the second at least one fluid outlet.

In some embodiments of the therapeutic fluid apparatus further includes a pressure control configured to control a pressure of fluid output by each of the first at least one fluid outlet and each of the second at least one fluid outlet.

In some embodiments of the therapeutic fluid apparatus at least a first fluid outlet of the first at least one fluid outlet and/or the second at least one fluid outlet includes a pressure control configured to control a pressure of fluid output by the first fluid outlet.

In some embodiments of the therapeutic fluid apparatus at least a first fluid outlet of the first at least one fluid outlet and/or the second at least one fluid outlet is rotatable within a defined range of rotation.

In some embodiments of the therapeutic fluid apparatus at least a first fluid outlet of the first at least one fluid outlet and/or the second at least one fluid outlet is closable.

In some embodiments of the therapeutic fluid apparatus further includes at least one pipe connecting the fluid pump to the first at least one fluid outlet and the second at least one fluid outlet.

In some embodiments of the therapeutic fluid apparatus the at least one support includes a non-slip material at a bottom of each support of the at least one support.

In some embodiments of the therapeutic fluid apparatus further includes a head portion connected to a top of the back portion, the head portion includes a third at least one fluid outlet oriented towards the seat portion. In some embodiments of the therapeutic fluid apparatus the head portion is removable from the therapeutic fluid apparatus.

In some embodiments of the therapeutic fluid apparatus further includes a left shoulder portion connected to a left side of the back portion, and a right shoulder portion connected to a right side of the back portion, where the left shoulder portion includes a third at least one fluid outlet, and where the right shoulder portion includes a fourth at least one fluid outlet. In some embodiments of the therapeutic fluid apparatus the left shoulder portion is removable from the therapeutic fluid apparatus, and where the right shoulder portion is removable from the therapeutic fluid apparatus.

In some embodiments of the therapeutic fluid apparatus includes a chair configured to receive a user positioned in front of the first at least one fluid outlet and in front of the second at least one fluid outlet.

In some embodiments of the therapeutic fluid apparatus the environment includes a bathtub.

In another aspect, a method of fluid therapy utilizing a therapeutic fluid apparatus includes placing a therapeutic fluid apparatus in an environment, the environment configured to be filled with a fluid to a minimum fluid height, activating the therapeutic fluid apparatus to direct at least a first portion of fluid to a first at least one fluid outlet of the therapeutic fluid apparatus and direct at least a second portion of fluid to a second at least one fluid outlet of the therapeutic fluid apparatus, and removing the therapeutic fluid apparatus from the environment.

In some embodiments the method further includes securing a flexible border material along at least a portion of a boundary of the environment, where the flexible border material increases a height at the portion of the boundary to exceed the minimum fluid height before the environment is filled with the fluid.

In some embodiments the method further includes filling the environment with the fluid.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a front perspective view of an example therapeutic fluid apparatus in accordance with at least some example embodiments of the present disclosure.

FIG. 1B illustrates a side orthographic view of an example therapeutic fluid apparatus in accordance with at least some example embodiments of the present disclosure.

FIG. 1C illustrates a back orthographic view of an example therapeutic fluid apparatus in accordance with at least some example embodiments of the present disclosure.

FIG. 2 illustrates a front perspective view of another example therapeutic fluid apparatus in accordance with at least some example embodiments of the present disclosure.

FIG. 3 illustrates an example therapeutic fluid apparatus with a seat extender in accordance with at least some example embodiments of the present disclosure.

FIG. 4 illustrates an example flow of fluid by therapeutic fluid apparatus in accordance with at least some example embodiments of the present disclosure.

FIG. 5 illustrates an example therapeutic fluid apparatus with a head portion in accordance with at least some example embodiments of the present disclosure.

FIG. 6 illustrates a front orthographic view of a head portion of a therapeutic fluid apparatus in accordance with at least some example embodiments of the present disclosure.

FIG. 7 illustrates a side orthographic view of an example therapeutic fluid apparatus with a separate foot therapeutic apparatus in accordance with at least some example embodiments of the present disclosure.

FIG. 8 illustrates an example therapeutic fluid apparatus directing fluid from an example environment in accordance with at least some example embodiments of the present disclosure.

FIG. 9 illustrates an example therapeutic fluid apparatus directing fluid from an example environment in accordance with at least some other example embodiments of the present disclosure.

FIG. 10 illustrates an example roll of flexible border material usable to enclose a particular environment boundary to a minimum fluid height in accordance with at least some example embodiments of the present disclosure.

FIG. 11 illustrates a method of utilizing a therapeutic fluid apparatus for fluid therapy in accordance with at least some embodiments of the present disclosure

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

Overview

To treat particular physical ailments and generally increase comfort of particular users, fluid therapy techniques were created that utilize targeted spraying of fluids (e.g., water) along various points of a user's body. In this regard, it is desirable to target each spray of fluid at particular points along the user's body. For example, in circumstances where the user has ailments that cause back problems, it may be desirable to spray fluid directed towards various points along the user's back, whereas in circumstances where the user has ailments that cause leg problems, it may be desirable to spray fluid directed towards various point along the user's legs.

Certain fluid therapy units have been created that attempt to provide this therapy to users in various contexts. Often, such units require configuring for particular integration with the environment in which the unit is to be used. For example, in the context where a water therapy unit is to be installed within a user's home bathroom, such units often require integration with the existing shower and/or bath systems to enable the water therapy units to function. This integration in some contexts requires permanently altering the environment, damaging the environment (even if temporarily) to integrate the water therapy unit, and/or otherwise disturbing the existing look and functionality of the environment within which the water therapy unit is to be used. In some particular contexts, such altering of the environment to integrate the water therapy unit may be restricted, such as in the context where the user is renting and not permitted to alter their environment. Even in circumstances where the environment may be altered, such existing units are often bulky and/or otherwise fixed such that it is impractical or entirely impossible to relocate the water therapy unit in a circumstance where it is desirable to do so (e.g., when the user moves, is temporarily relocating, and/or the like). Additionally still, existing water therapy units often are costly to obtain and/or install, further complicated by the increased cost to configure the unit for integration within the environment.

Embodiments of the present disclosure include specially configured apparatuses that may be removably placed within an environment for operation without damaging or permanently altering the environment. Embodiments include therapeutic fluid apparatuses that operate to produce one or more fluid stream(s), such as pressurized water streams, via one or more fluid outlet(s) of the therapeutic fluid apparatus. The fluid outlet(s) in some such embodiments are aligned at particular positions, such that the resulting fluid stream(s) produced via such fluid outlet(s) impact particular positions along a user's body when the user is positioned upon the apparatus as intended (e.g., seated). Some such embodiments utilize one or more pump(s) that direct fluid from the environment surrounding the therapeutic fluid apparatus for use. In this regard, some such embodiments provide a continuous flow of fluid that utilizes fluid recirculation to minimize the amount of wasted fluid during operation of the therapeutic fluid apparatus. Additionally or alternatively, in some such apparatus(es) are configured utilizing light weight materials to enable portability of the apparatus without requiring significant user strength and/or use of external machinery.

The term “therapeutic” refers to an improved feeling of comfort or improvement in one or more symptoms of a physical ailment affecting a user.

Structure of Example Therapeutic Fluid Apparatuses of the Disclosure

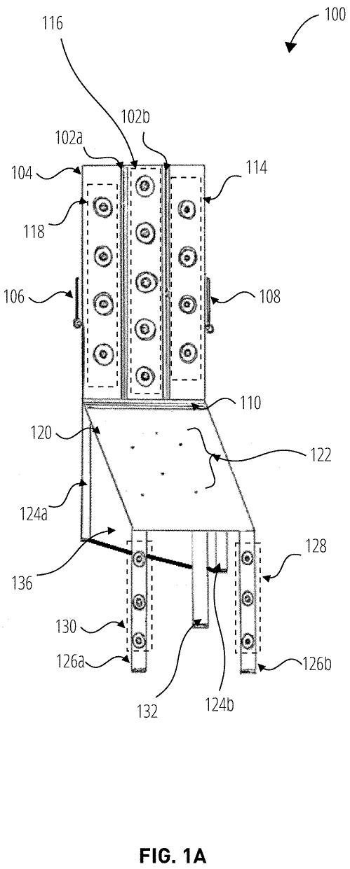

FIG. 1A illustrates a front perspective view of an example therapeutic fluid apparatus in accordance with at least some example embodiments of the present disclosure. Specifically, FIG. 1A depicts an example therapeutic fluid apparatus 100. FIG. 1B illustrates a side orthographic view of an example therapeutic fluid apparatus in accordance with at least some example embodiments of the present disclosure, specifically the therapeutic fluid apparatus 100. FIG. 1C illustrates a back orthographic view of an example therapeutic fluid apparatus in accordance with at least some example embodiments of the present disclosure, specifically the therapeutic fluid apparatus 100. As described herein, the “front” is depicted as towards the forward-facing direction of the therapeutic fluid apparatus 100 with respect of the front edge of the seat portion being to the direction opposite the position of the back portion. All other directions are described with respect to this forward-facing direction

In some embodiments, the therapeutic fluid apparatus 100 is configured to support a user. The therapeutic fluid apparatus 100 is specially configured to intake fluid from an environment around therapeutic fluid apparatus 100, and spray the fluid via some or all of a plurality of fluid outlets connected to the therapeutic fluid apparatus 100. The user may place themselves of otherwise sit on at least a portion of the therapeutic fluid apparatus 100 in front of the fluid outlets. For example, in some embodiments, the therapeutic fluid apparatus 100 embodies or otherwise includes a specially configured seat. Alternatively or additionally, in some embodiments, the therapeutic fluid apparatus 100 embodies or otherwise includes a specially configured chair.

The therapeutic fluid apparatus 100 comprises a seat portion 120. The seat portion 120 includes or embodies a horizontal surface or substantially horizontal surface. In some embodiments, the seat portion 120 is configured to support the bottom of a user while the user is seated upon the therapeutic fluid apparatus 100. The user may sit on the seat portion 120 to position themselves during operation of the therapeutic fluid apparatus 100. In some embodiments, the seat portion 120 optionally includes fluid drainage cavities 122. The fluid drainage cavities 122 provide a path where fluid engaging the seat portion 120 can drain back into the environment around the therapeutic fluid apparatus 100. In this regard, the fluid drainage cavity 122 prevents fluid from pooling on the seat portion 120. Alternatively or additionally, in some embodiments, the seat portion 120 is concave to route fluid engaging the seat portion 120 towards the center of the seat portion 120, for example to drain such fluid via the fluid drainage cavities 122. In some embodiments, the seat portion 120 includes a padded head rest portion at least at the front edge of the top edge of the seat portion 120 and that extends at least along the width of the seat portion 120. In some embodiments, the padded head rest portion embodies a defined portion of material configured to support a user's head when leaning back against the back portion 104 of the therapeutic fluid apparatus 100.

The therapeutic fluid apparatus 100 comprises a back portion 104. The back portion 104 includes or embodies a vertical surface or substantially horizontal surface. In some embodiments, the back portion 104 is configured to support the back of the user while the user is seated upon the therapeutic fluid apparatus 100. In some embodiments, the back portion 104 is connected to the seat portion 120. In some such embodiments, the seat portion 120 and the back portion are connected via one or more rivets, screws, nails, or other known mechanisms for securely connecting the back portion 104 and the seat portion 120. Alternatively or additionally, in some embodiments, the back portion 104 and the seat portion 120 are molded together as a single piece. Alternatively or additionally still, in some embodiments the back portion 104 and the seat portion 120 are fused together, for example via welding.

In some embodiments, the seat portion 120 is fixedly attached to the back portion 104. In some embodiments, the seat portion 120 and the back portion 104 are positioned in a defined positional relationship with one another. For example, in some embodiments, the back portion 104 is affixed at a certain orientation with respect to the orientation of the seat portion 120. In other embodiments, the back portion 104 is configured to recline and/or otherwise may be configurable to any of a number of configured orientations. In some embodiments, the back portion 104 is spaced from the seat portion 120. In some embodiments, the back portion 104 is removable from the seat portion 120 entirely.

In some embodiments, the therapeutic fluid apparatus 100 includes a frame that connects to some or all of the components of the therapeutic fluid apparatus 100. In some such embodiments, the positional relationship is defined by the frame. For example, in some embodiments, the seat portion 120 is fixedly attached to a first, horizontal portion of the frame, and the back portion 104 is fixedly connected to a second, vertical portion of the frame. Additionally or alternatively, in some embodiments, the frame is defined by and/or fixedly connected to one or more support(s) of the therapeutic fluid apparatus 100. The frame may similarly be constructed of any of the rigid materials described herein.

In some embodiments, the back portion is of a standard chair size. In some embodiments, the back portion 104 is 16 inches wide (e.g., from side to side) and 30 inches long (e.g., from top to bottom). Additionally or alternatively, in some embodiments, the back portion is of any depth (e.g., from back to front) that enables fitting of piping for fluidically coupling the fluid outlet(s) thereof a fluid pump.

In some embodiments, the seat portion 120 is of a standard chair size. In some embodiments, the seat portion 120 is 16 inches wide (e.g., from side to side) and 18 inches long (e.g., from front to back). Additionally or alternatively, in some embodiments, the seat portion 120 is of any depth.

The back portion 104 includes a plurality of fluid outlets, including at least fluid outlets 114, fluid outlets 116, and fluid outlets 118. In some embodiments, at least one fluid outlet is recessed at least in part within the interior of the back portion 104. In other embodiments, at least one fluid outlet is entirely recessed within the interior of the back portion 104, such that an opening of the at least one fluid outlet does not break a vertical plane defined by the back portion 104. Alternatively or additionally still, in some embodiments, at least one fluid outlet extends outwardly from a forward-facing side of the back portion 104 (e.g., towards where a user may be seated upon the therapeutic fluid apparatus 100).

Each fluid outlet is configured to produce a stream of fluid. In some embodiments, each fluid outlet produces a pressurized stream of fluid embodying a sprayed stream of fluid at a particular pressure value. Non-limiting examples of a fluid outlet include a nozzle, a fluid jet, an aperture, and/or the like. Each fluid outlet is connected to the back portion 104. In some embodiments, each fluid outlet is connected to the back portion 104 utilizing one or more securing mechanism(s), including and without limitation a screw, rivet, nail, bolt, and/or the like. Alternatively or additionally, in some embodiments each fluid outlet is molded as part of the back portion 104. Alternatively or additionally still, in some embodiments each fluid outlet is permanently secured to the back portion 104, for example via welding a housing of a particular fluid outlet with the back portion 104.

Each fluid outlet produces an independent stream of fluid. In this regard, it will be appreciated that each fluid outlet of the fluid outlets 114, 116, and 118 may produce a stream of fluid from a different position along a forward-facing side of the back portion 104. While a user is positioned engaging the therapeutic fluid apparatus 100 (e.g., sitting upon the therapeutic fluid apparatus 100), each produced fluid stream may make contact at a different point along the user's body. The force of the fluid stream making contact with the user's body can provide various therapeutic benefits (e.g., improving circulation, relaxing muscles, and/or the like) and/or provide improved comfort to the user (e.g., by providing a massage-like effect).

The back portion 104 optionally includes one or more spacers, for example the spacers 102a and 102b as depicted. In some embodiments, each spacer embodies or otherwise includes a portion of rigid material positioned vertically along the back portion 104. Each spacer is a particular thickness normal to the plane defining the back portion 104, such that the spacers define a space between the back portion 104 and the back of a user positioned upon the therapeutic fluid apparatus 100. In this regard, spacer 102a and spacer 102b prevent the back of a user from directly making contact with the fluid outlets of the therapeutic fluid apparatus 100, for example to prevent the user's back from blocking one or more fluid outlet(s) from producing a stream of fluid during operation of the therapeutic fluid apparatus 100.

In some embodiments, the spacer 102a and/or spacer 102b is constructed of a pure metal to prevent rust. Alternatively or additionally, in some embodiments the spacer 102a and/or spacer 102b is constructed of a metal coated or otherwise imbued with any substance known to reduce or prevent rust. Alternatively or additionally still, in some embodiments the spacer 102a and/or spacer 102b is constructed of any material that compresses to a minimum threshold thickness to ensure that space remains between the fluid outlets along the back portion 104 and the user while the user is seated in the therapeutic fluid apparatus 100 and applying force to the spacers 102a and 102b. Non-limiting examples of other materials utilizable to contract the spacer 102a and/or the spacer 102b include rubber, silicon, and waterproof fabric, or any combination thereof. Alternatively or additionally, in some embodiments a spacer includes a metal rod or rectangle of any height cushioned with a waterproof material to provide improved comfort to the user when seated on the therapeutic fluid apparatus 100.

In some embodiments, one or more spacer(s) define different section(s) of the back portion 104. In some embodiments, each of the section(s) includes at least one fluid outlet positioned within the section. For example, as illustrated, the spacer 102a and spacer 102b divide the back portion 104 into three sections, for example a left section, a right section, and a middle section. The left section includes a plurality of fluid outlets 114, the middle section includes a plurality of fluid outlets 116, and the right section includes a plurality of fluid outlets 118. In this regard, the fluid outlets 114 may produce fluid streams that make contact with the user at different points than the fluid outlets 116 and the fluid outlets 118. For example, in a circumstance where a user is seated upon the therapeutic fluid apparatus 100, the fluid outlets 114 may produce fluid streams that make contact with positions along a left portion of a user's back, whereas the fluid outlets 116 may produce fluid streams that make contact with positions along a middle portion of the user's back, and the fluid outlets 118 may produce fluid streams that make contact with positions along a right portion of the user's back.

The therapeutic fluid apparatus 100 further includes a horizontal spacer 110. The horizontal spacer 110 is positioned at the connection point where the seat portion meets the back portion. In this regard, the horizontal spacer 110 defines a buffer of space between the back portion 104 and the bottom of the user when positioned upon the therapeutic fluid apparatus 100.

In some embodiments, the spacers 102a, 102b, and 110 have a thickness of 1½ inches in a forward facing direction (e.g., towards a front edge of the seat portion 120), and a width of 1 inch in a horizontal direction. Additionally or alternatively, in some embodiments, the spacers 102a, 102b extend for the height of the back portion 104, and the spacer 110 extends for the width of the seat portion 120. It will be appreciated that, in other embodiments, the spacers may have any other dimensions as desired.

In some embodiments, the therapeutic fluid apparatus 100 embodies a seat, chair, or other apparatus upon which a user may sit. In some such embodiments, one or more of the depicted portion(s) may be optional and/or modified. For example, in some embodiments, the therapeutic fluid apparatus 100 embodies a stool, such that the back portion 104 is not required. Additionally or alternatively, in some embodiments, the seat portion 120 is of a different shape, dimension(s), and/or the like. For example, in some embodiments the seat portion 120 is circular. In other embodiments, the seat portion 120 is extended such that the user may sit upon the seat portion 120 with their legs extended.

In some embodiments, one or more of the fluid outlet(s), such as the fluid outlets 114, 116, 118, 128, and/or 130, is closable. In this regard, such fluid outlet(s) may be set to a closed position that prevents the fluid outlet from producing a fluid stream. Similarly, such a fluid outlet may produce a fluid stream when set to a second, open position. In some embodiments, each fluid outlet is associated with an independent control for controlling whether the fluid outlet is open or closed. In one example embodiment, a fluid outlet includes or otherwise is associated with a lever positioned on or otherwise connected to the fluid outlet that individually controls whether that fluid outlet is set to an open position or a closed position. In other embodiments, any of a myriad of other known controls for closing and/or opening a fluid outlet may be utilized.

In some embodiments, one or more of the fluid outlet(s), such as the fluid outlets 114, 116, 118, 128, and/or 130, is configured to rotate in place to reorient the fluid outlet, such that the particular fluid outlet rotatable. Upon rotating the fluid outlet, that fluid outlet may produce a water stream in a direction determined by the rotation of the fluid outlet. In some embodiments, each fluid outlet is rotatable around an axis normal to the back portion 104 according to one or more three-dimensional rotation(s). For example, in some embodiments, a fluid outlet is rotatable within one or more maximum rotation ranges in each of the three-dimensional rotations. In one such example context, each fluid outlet is rotatable up to 45 degrees from the normal vector of the back portion 104, and/or otherwise from a default orientation of the fluid outlet. Alternatively or additionally, in some embodiments, one or more fluid outlet(s) is configured to swivel around an anchor point to rotate the fluid outlet.

In some embodiments, all fluid outlets of the therapeutic fluid apparatus 100 are controlled together. For example, in some embodiments the therapeutic fluid apparatus 100 includes a single pressure control that controls the pressure used to produce a fluid stream by each fluid outlet of the therapeutic fluid apparatus 100. In some embodiments, the pressure control is embodied by or integrated with the fluid pump 136 as depicted and described herein. Alternatively or additionally, in some embodiments, the therapeutic fluid apparatus 100 includes a plurality of pressure controls, where each pressure control controls a pressure of a portion of the fluid outlets of the therapeutic fluid apparatus 100. In some embodiments, each of the one or more the fluid outlet(s) includes or otherwise is associated with an individual pressure control that controls the pressure for that fluid outlet specifically. For example, in some embodiments at least one fluid outlet is configured with a twist-based flow control that alters the pressure of the produced water stream in response to twisting of the fluid outlet (e.g., clockwise twist to reduce pressure, counterclockwise twist to increase pressure).

The therapeutic fluid apparatus 100 optionally includes one or more arm rests, such as the arm rest 106 and arm rest 108. In some embodiments, each arm rest is configured to support a user's arm and/or elbow while the user is positioned upon (e.g., seated) the therapeutic fluid apparatus 100. As illustrated, the therapeutic fluid apparatus 100 includes the arm rest 106 embodying a right arm rest and further includes the arm rest 108 embodying a left arm rest. In this regard, the arm rest 106 is connected to a right side of the back portion 104, and the arm rest 108 is connected to a left side of the back portion 104. It will be appreciated that each of the arm rests 106 and 108 may be connected to the back portion 104 utilizing any of a myriad of securing mechanisms, including and without limitation one or more rivets, screws, bolts, nails, and/or the like. Alternatively or additionally, in some embodiments, the arm rest 106 and/or arm rest 108 is molded to the back portion 104 as a single piece. Alternatively or additionally still, in some embodiments the arm rest 106 and/or arm rest 108 is welded or otherwise permanently secured to the back portion 104.

In some embodiments, the therapeutic fluid apparatus 100 comprises an arm rest that is moveably rotatable. In this regard, the arm rest may be moveably rotatable along a particular axis of rotation, for example between a first position having a first orientation and a second position having a second orientation. In some embodiments, the arm rest is moveably rotatable from a vertical orientation (e.g., where the arm rest is pointed upwards) to a horizontal orientation (e.g., where the arm rest is pointed in a forward-facing direction with respect to the therapeutic fluid apparatus 100). Alternatively or additionally, in some embodiments, the arm rest is moveably rotatable between a plurality of positions having a plurality of orientations. In some embodiments, the arm rest is connected to the back portion 104 of the therapeutic fluid apparatus 100 utilizing one or more hinge(s) configured to enable rotation of the arm rest from a first orientation to a second orientation. As illustrated, for example, each of the arm rests 106 and 108 are oriented in a vertical orientation, and may be moveably rotated (e.g., automatically or via a user-applied force along the axis of rotation) to a horizontal orientation directed in a forward-facing direction with respect to the therapeutic fluid apparatus 100.

In some embodiments, the therapeutic fluid apparatus 100 includes one or more support(s) that make contact with the ground of an environment. For example, in some embodiments, the supports include or embody chair legs that support the weight of a user when the user places themselves in the therapeutic fluid apparatus 100 (e.g., by sitting). In some embodiments, one or more support(s) is/are connected to one or more portion(s) of the therapeutic fluid apparatus 100 where the user is to place themselves. For example, as illustrated the therapeutic fluid apparatus 100 includes a plurality of supports, including support 124a, support 124b, support 126a, support 126b. These supports are connected to the seat portion 120 of the therapeutic fluid apparatus 100, such that each support is connected at a different corner of the seat portion 120 (e.g., support 124a connected at the back right corner, support 124b connected at the back left corner, support 126a connected at the front right corner, and support 126b connected at the front left corner). It will be appreciated that, in other embodiments, one or more support(s) connects to a different portion of the therapeutic fluid apparatus 100, for example connecting to the back portion 104, through the seat portion 120, and/or the like.

In some embodiments, each support is constructed of a pure metal to prevent rust. In some such embodiments, the support is constructed of aluminum, and/or aluminum alloy(s), as a lightweight option with sufficient strength relative to other metals. In this regard, the lightweight nature of such material improves the portability of the therapeutic fluid apparatus 100. Alternatively or additionally, in some embodiments one or more of the support(s) is constructed of a metal coated or otherwise imbued with any substance known to reduce or prevent rust. In some embodiments, one or more support(s) are constructed of fiberglass, plastic, and/or a mix of the materials described herein to provide sufficient weight support at a desired weight of the therapeutic fluid apparatus 100.

The support(s) connected to the therapeutic fluid apparatus 100 are sufficient to support a desired weight placed in the seat portion 120 (e.g., the weight of a user when sitting on the seat portion 120). In this regard, it will be appreciated that the supports of the therapeutic fluid apparatus 100 may be configured utilizing any such style, shape, and/or construction of chair support that enables supporting of the desired weight and maintaining balance of a center of gravity of the therapeutic fluid apparatus 100 (e.g., to prevent the therapeutic fluid apparatus 100 from tipping over). In some embodiments, the support(s) connected to the therapeutic fluid apparatus 100 include a single support aligned to the center of the of seat portion 120, and that extends radially (e.g., as a circularly-shaped support) or towards one or more sides of the seat portion 120 (e.g., as a rectangularly-shaped or box support).

In some embodiments, the therapeutic fluid apparatus 100 optionally includes one or more intermediary support(s), for example the intermediary support 132. The intermediary support 132 is connected to the seat portion 120 at a position located between the connection points for one or more back support(s) and one or more front support, for example between the connection points for back supports 124a and 124b and the connection points for front supports 126a and 126b. In some embodiments, the intermediary support(s) increase the maximum force that can be applied to the therapeutic fluid apparatus 100 before one or more component(s) of the therapeutic fluid apparatus 100 experiences a failure (e.g., breaks, bends permanently, separates, and/or otherwise fails), for example due to the weight of a user when seated upon the therapeutic fluid apparatus 100. Additionally or alternatively, in some embodiments the intermediary support(s) increase the stability of the therapeutic fluid apparatus 100. In some embodiments a single intermediary support is positioned aligned with the center of the seat portion 120, for example the intermediary support 132 as depicted. In other embodiments, a plurality of intermediary supports are positioned at various positions between one or more front support(s) (e.g., the supports 126a and 126b) and one or more back support(s) (e.g., the supports 124a and 124b). In some embodiments, the front corresponds to the forward half defined from a center point of the seat portion 120, and the back corresponds to the rear half defined from the center point of the seat portion 120. In this regard it will be appreciated that in some embodiments “front” need not be at any particular position in the front half or necessarily be the forward-most component, and similarly “back” need not be at any particular position in the back half or necessarily be the rear-most component.

In some embodiments, the front support(s) of the therapeutic fluid apparatus 100 (e.g., supports 126a and 126b) connect to the seat portion 120 at a minimum distance from the front edge of the seat portion 120. In this regard, the minimum distance may enable a defined space between a leg of a user and one or more fluid outlet(s) in the front support(s) while the user is seated or otherwise positioned upon the seat portion 120. For example, in some embodiments, the front support(s) are connected such that at least a 1½ inch gap remains between the front edge of the seat portion 120 and the front support(s) along the entirety of the support.

In some embodiments, the support(s) of the therapeutic fluid apparatus 100 define or is/are connected to a frame. In some such embodiments, the frame defines the position of each support and/or the back portion 104 and/or seat portion 120. In some embodiments, the frame includes one or more cross-members that connect two or more support(s), the left and right side or front and back side of any of the component(s), and/or the like.f

The support(s) of the therapeutic fluid apparatus 100 are connected to the seat portion 120, and/or other portion(s) of the therapeutic fluid apparatus 100, utilizing any of the mechanisms described herein and/or known in the art. In some embodiments, one or more of the support(s), such as the support 124a, support 124b, support 126a, support 126b, and/or support 132, is connected to the seat portion 120 (or other portion of the therapeutic fluid apparatus 100) utilizing one or more securing mechanism(s), including and without limitation screws, bolts, nails, rivets, and/or the like. Alternatively or additionally, in some embodiments, one or more of the support(s) integrates with the seat portion 120 by snapping into place. Alternatively or additionally still, in some embodiments, one or more support(s) is molded to the seat portion 120, and/or one or more other portion(s) of the therapeutic fluid apparatus 100, as a single piece. Alternatively or additionally still, in some embodiments, one or more of the support(s) is permanently connected to the seat portion 120, and/or one or more other portion(s) of the therapeutic fluid apparatus 100, for example by welding or other means for fusing two previously separate components.

In some embodiments, some or all of the support(s) of the therapeutic fluid apparatus 100 include a non-slip material at the bottom, or substantially at the bottom (e.g., as a footing or cap), of the support. The non-slip material may be configured to increase the force required to slide or otherwise move the therapeutic fluid apparatus 100 horizontally within an environment. In some embodiments the non-slip material provides an increase in force required to slide or otherwise move the therapeutic fluid apparatus 100 in a wet environment, such as while positioned in a bath tub or shower. In this regard, the non-slip material reduces the likelihood of undesired movement of the therapeutic fluid apparatus 100. As illustrated, the therapeutic fluid apparatus 100 includes a non-slip material at the bottom of each of the supports support 124a, support 124b, 126a, 126b, and 132 that caps each respective support with the non-slip material. Non-limiting examples of the non-slip material include rubber, silicon, plastic, or the like.

In some embodiments, at least some of the supports of the therapeutic fluid apparatus 100 include one or more fluid outlet(s). In some embodiments, the therapeutic fluid apparatus 100 includes one or more support(s) that include fluid outlet(s) directed towards a front of the therapeutic fluid apparatus 100 (e.g., according to a defined forward-facing direction). In this regard, in some embodiments the therapeutic fluid apparatus 100 includes fluid outlet(s) integrated with or otherwise connected to the support(s) closest to the front of the seat portion 120. For example, as illustrated, the therapeutic fluid apparatus 100 includes fluid outlets 130 in the front right support 126a and the fluid outlets 128 in the front left support 126b. Each of the fluid outlets 128 and 130 produce fluid streams in a forward-facing direction that matches the forward-facing direction of the seat portion 120, such that the fluid streams produced by the fluid outlets 128 and 130 may make contact with a user's body when the user is seated upon the therapeutic fluid apparatus 100. In some embodiments, the fluid outlets are positioned in support(s) that are likely to align with a user's legs while the user is seated upon the therapeutic fluid apparatus 100.

The fluid outlet(s) connected to or otherwise integrated with the supports of the therapeutic fluid apparatus 100 produce fluid streams at different points than the fluid outlet(s) connected to or otherwise integrated with the back portion 104 as described herein. In this regard, it will be appreciated that while a user is positioned upon the therapeutic fluid apparatus 100, the fluid streams produced by the fluid outlets in the support(s) may make contact with the user's body at different points than the fluid streams produced by the fluid outlets in the back portion 104. In this regard, the user may position themselves on the therapeutic fluid apparatus 100 such that some or all of the water streams produced by the various fluid outlets, for example fluid outlets 114, 116, 118, 128, and/or 130, make contact with desired portion(s) of the user's body.

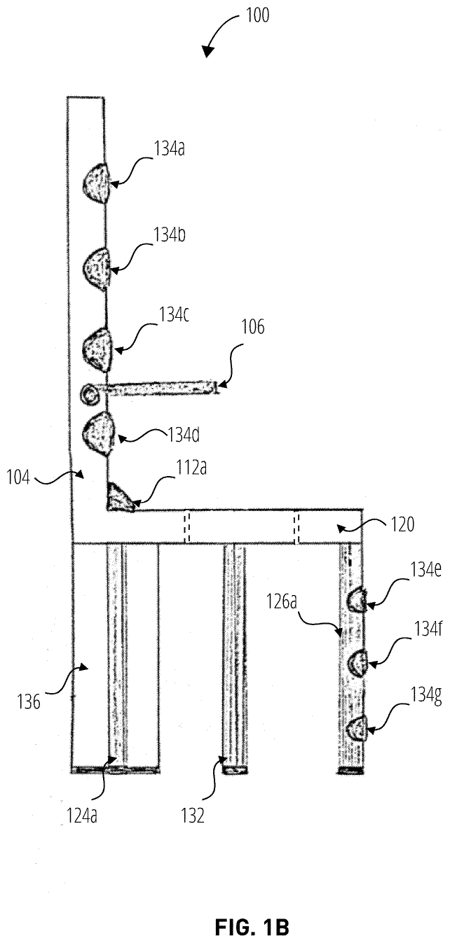

The support(s) of the therapeutic fluid apparatus 100 may be of any height desired. For example, the height of the support(s) may vary in various embodiments to enable a user to comfortably position themselves on the therapeutic fluid apparatus 100, comfortably remove themselves from the therapeutic fluid apparatus 100, and/or comfortably rest while positioned upon (e.g., seated on) the therapeutic fluid apparatus 100. For example, in some embodiments, the support(s) of the therapeutic fluid apparatus 100 embody a height of 18 inches to provide a moderate sitting height. Alternatively or additionally, in some embodiments, the support(s) embody lower height, for example 4 inches as depicted with respect to therapeutic fluid apparatus 200 in FIG. 2. The therapeutic fluid apparatus 200 may otherwise include the same components and configurations as the therapeutic fluid apparatus 100 as depicted and described with respect to FIGS. 1A, 1B, and 1C. It will be appreciated that the lower height of the support(s) decreases the height at which the seat portion of the therapeutic fluid apparatus 200 is positioned. In this regard, the user may be seated in the therapeutic fluid apparatus 200 while submerged in a fluid surrounding the therapeutic fluid apparatus 200, for example while in a filled bath tub. It will be appreciated that, in some embodiments, some or all of the fluid outlets, such as the fluid outlets 114, fluid outlets 116, fluid outlets 118, fluid outlets 128, fluid outlets 130, and/or the like, operate while submerged within a fluid. In some embodiments, one or more of such fluid outlet(s) include a one-way flow control that prevents flow of fluid into the fluid outlet from a nozzle in contact with fluid of the environment.

The therapeutic fluid apparatus 100 includes at a fluid pump 136 that provides pumping of fluid utilized by the therapeutic fluid apparatus 100. In some embodiments, the fluid pump 136 is fluidically coupled with each fluid outlet of the therapeutic fluid apparatus 100, for example via piping that connects from the fluid pump 136 to each of the fluid outlet(s). In some embodiments, the pipes are internal to one or more component(s) of the therapeutic fluid apparatus 100, for example defined internal to one or more of the support(s), the back portion 104, the seat portion 120, and/or any combination thereof. In other embodiments, some or all of the pipes that couple the fluid pump 136 to one or more fluid outlet(s) is/are located external from the remaining component(s) of the therapeutic fluid apparatus 100, for example along the bottom or side of the seat portion 120, the bottom or side of the back portion 104, and/or the like. The fluid pump 136 is configured to pump fluid from the environment surrounding the therapeutic fluid apparatus 100 via one or more inlet(s). The fluid is subsequently pumped to each of the fluid outlets of the therapeutic fluid apparatus 100, for example one or more of the fluid outlets 114, 116, 118, 128, and/or 130. In some embodiments, the fluid pump 136 embodies or includes a sump that intakes the fluid and/or directs it throughout the therapeutic fluid apparatus 100. In some embodiments, the fluid pump 136 is embodied by a single pump. In some embodiments, the fluid pump 136 is embodied by a plurality of sub-pumps operating in conjunction with one another.

In some embodiments, the fluid pump 136 is located towards the rear of the therapeutic fluid apparatus 100. For example, in some embodiments, the fluid pump 136 is located between two or more rear support(s) of the therapeutic fluid apparatus 100, such as the supports support 124a and support 124b. In other embodiments, the fluid pump 136 is located at or substantially towards the center of the seat portion 120 to provide additional support. Alternatively or additionally still, in some embodiments the fluid pump 136 is fixedly connected to the therapeutic fluid apparatus 100 at any point, and the fluid pump 136 includes an inlet (e.g., attached to a hose) that is configured to be positioned within a capacity of fluid (e.g., below a water line).

In some embodiments, the fluid pump 136 includes a battery that powers activation of the pump and/or other component(s) of the therapeutic fluid apparatus 100. In some such embodiments, the battery is electronically coupled (e.g., via wiring) with the pump and/or other component(s) of the therapeutic fluid apparatus 100 that require power to provide such power to each of such component(s). In some embodiments, the battery embodies a lithium-ion battery chargeable utilizing an AC power connection or a DC power connection. Additionally or alternatively, in some embodiments the fluid pump 136 includes a toggle utilized to activate and/or deactivate power to the therapeutic fluid apparatus 100. For example, in some embodiments the toggle is electronically coupled to the battery to control whether power is drawn from the battery to one or more other component(s) of the therapeutic fluid apparatus 100. In some embodiments, the toggle embodies a switch, button, lever, or other mechanism utilized to switch between an “on” position and an “off” position.

In some embodiments, the therapeutic fluid apparatus 100 utilizes recirculation of fluid to enable a continuous flow of fluid, or almost continuous flow of fluid (e.g., where a small amount of fluid is consumed over time, such as by being applied to and/or absorbed by a user and/or element(s) of the environment), during operation of the therapeutic fluid apparatus 100. For example, the fluid pump 136 intakes fluid from the environment that is directed to one or more fluid outlet(s) of the fluid outlets 114, 116, 118, 128, and/or 130. The fluid outlet(s) then produce fluid stream(s) utilizing such fluid. The fluid stream(s) make contact with a user or spray back into the environment surrounding the therapeutic fluid apparatus 100. In this regard, in a circumstance where the environment surrounding the therapeutic fluid apparatus 100 is contained, as the fluid is sprayed back into the environment surrounding the therapeutic fluid apparatus 100 pools and thereby enables the fluid pump 136 to again intake the fluid. In some such contexts, in a circumstance where the environment includes sufficient liquid to enable producing of all fluid streams simultaneously, the therapeutic fluid apparatus 100 thereby provides a continuous flow of all, or most, recirculated fluid, thus reducing or entirely eliminating any need for additional fluid be added to the environment as the therapeutic fluid apparatus 100 operates.

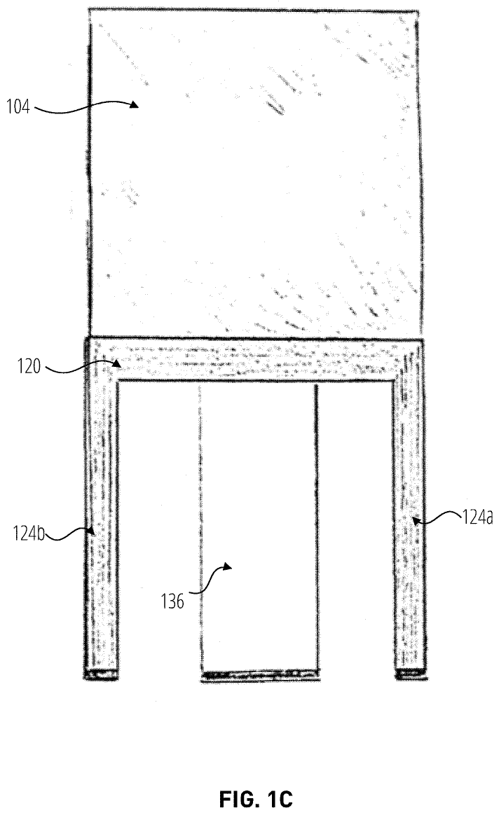

Optionally, in some embodiments the therapeutic fluid apparatus 100 (and/or therapeutic fluid apparatus 200) includes one or more additional and/or optional components. FIG. 3 illustrates an example therapeutic fluid apparatus with a seat extender in accordance with at least some example embodiments of the present disclosure. Specifically, FIG. 3 depicts a seat extender 302. The seat extender 302 is positioned on the therapeutic fluid apparatus 100 to expand the usable sitting area of the seat portion 120 in one or more direction(s). For example, in some embodiments the seat extender 302 is of a larger width than the seat portion 120. Additionally or alternatively, in some embodiments the seat extender 302 is of a larger depth than the seat portion 120. In this regard, the seat extender 302 may be placed upon the seat portion 120 to increase the area that may engage the bottom of a user while the user is positioned upon the therapeutic fluid apparatus 100.

The seat extender 302 may be configured and/or constructed similarly or identically to the seat portion 120. For example, in some embodiments the seat extender 302 and the seat portion 120 are made of the same material. Additionally or alternatively, in some embodiments, at least a top of the seat extender 302 is concave to route fluid towards the center of the seat extender 302 and/or in the direction of fluid drainage cavities 304a-304d.

In some embodiments, the seat extender 302 is secured to the therapeutic fluid apparatus 100. For example, in some embodiments, the seat extender 302 engages one or more groove(s) of the back portion 104 to lock into place. Alternatively or additionally, in some embodiments the seat extender engages the one or more spacer(s), such as the spacers 102a, spacer 102b, and/or spacer 110, to lock into place. In other embodiments, the seat extender 302 rests on top of the seat portion 120. In other embodiments, the seat extender 302 clips, screws in, or otherwise connects to the therapeutic fluid apparatus 100 utilizing one or more securing mechanism(s) described herein.

In some embodiments, the seat extender 302 includes one or more fluid drainage cavity. As illustrated, for example, the 302 includes fluid drainage cavity 304a, fluid drainage cavity 304b, fluid drainage cavity 304c, and fluid drainage cavity 304d, that extend through from the top of the seat extender 302 to the bottom of the seat extender 302. In this regard, fluid that makes contact with the seat extender 302 may be directed towards the fluid drainage cavities and drain through said fluid drainage cavities onto the seat portion 120 and/or back into the environment surrounding the therapeutic fluid apparatus 100. In some embodiments, the fluid that drains via the fluid drainage cavities 304a-304d subsequently engages the seat portion 120 and drains through the cavities thereof, for example the fluid drainage cavities 122. The one or more fluid drainage cavity thus reduces or eliminates pooling of fluid on the seat extender 302.

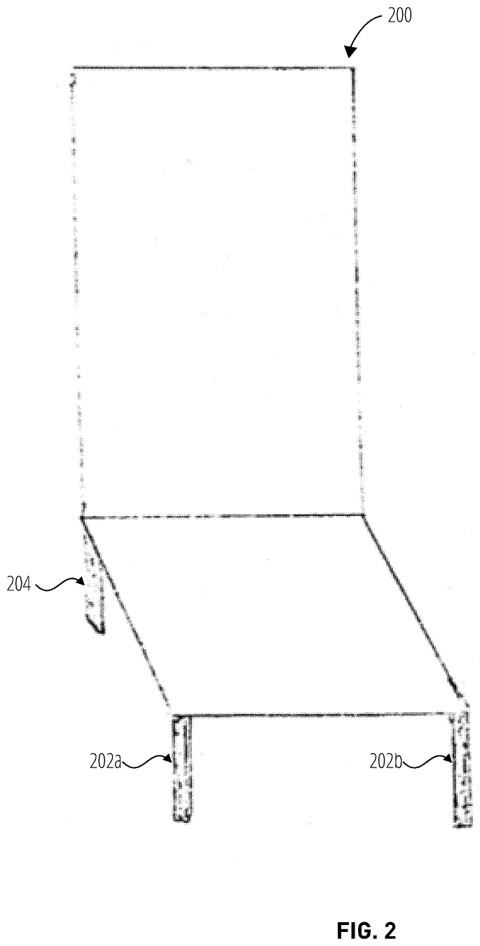

FIG. 4 illustrates an example flow of fluid by a therapeutic fluid apparatus in accordance with at least some example embodiments of the present disclosure. It will be appreciated that the specific flow of fluid depicted in FIG. 4 is meant to serve as an example and not to limit the scope and spirit of the disclosure. Accordingly, in other embodiments, the therapeutic fluid apparatus may utilize a flow of fluid that differs from the fluid flow depicted and described with respect to FIG. 4. Additionally or alternatively, in some embodiments, a single flow of fluid depicted and described with respect to FIG. 4 are embodied by a plurality of individual flows of fluid. It is intended for all such embodiments to be within the scope of this disclosure and covered within the scope of the attached claims. For purposes of consistency and ease of disclosure, the flow of fluid is described with respect to the therapeutic fluid apparatus 100.

FIG. 4 depicts a flow of fluid from an environment surrounding a therapeutic fluid apparatus 100 to the fluid outlets of the therapeutic fluid apparatus 100. In some embodiments, the therapeutic fluid apparatus 100 includes any number of pipes, tubes, and/or other conduits (“piping”) that direct the flow of fluid accordingly. It will be appreciated that such piping may be constructed of any of a myriad of known materials suitable for directing fluids without causing damage to the piping. Such piping in some embodiments is entirely housed within the components of the therapeutic fluid apparatus 100, for example interior to the support(s), back portion, seat portion, and/or the like. Alternatively or additionally, in some embodiments such piping includes one or more pipes, tubes, conduits, and/or the like, that is/are positioned external from the housings of the components of therapeutic fluid apparatus 100.

FIG. 4 depicts a plurality of fluid flow indicators, represented by arrows, that indicate the flow of fluid as the therapeutic fluid apparatus 100 operates. In some embodiments, this flow may be continuous and/or otherwise continue while the therapeutic fluid apparatus 100 continues to operate. In this regard, the flow of fluid may continue until the therapeutic fluid apparatus 100 is powered down, shut off, or otherwise deactivated. In some embodiments, the remaining fluid is flushed from the therapeutic fluid apparatus 100 once the therapeutic fluid apparatus 100 is powered down, shut off, or otherwise deactivated. Additionally or alternatively, in some embodiments the therapeutic fluid apparatus 100 includes one or more fluid releases or outlets that recirculate unused fluid back into the environment surrounding the therapeutic fluid apparatus 100 in a circumstance where such fluid is not utilized in a water stream (e.g., because one or more fluid outlet of the therapeutic fluid apparatus 100 is closed).

In some embodiments, the therapeutic fluid apparatus 100 requires a minimum fluid height to enable intake of fluid via a fluid pump and/or continuous flow of fluid. For example, in some embodiments, the minimum fluid height is determined based at least in part by a minimum fluid height that can be collected by the fluid pump. Alternatively or additionally, in some embodiments the minimum height of fluid defines a minimum volume of fluid within a particular environment surrounding the therapeutic fluid apparatus 100. As illustrated, for example, the therapeutic fluid apparatus 100 is depicted associated with a minimum fluid height 402 that enables continuous flow of fluid via the depicted and described fluid flow. In some embodiments, the minimum fluid height is defined based on a minimum fluid capacity required to continuously operate the therapeutic fluid apparatus 100, and/or one or more physical dimensions of the environment to be filled with fluid.

The fluid flow begins with directing of fluid from the environment surrounding the therapeutic fluid apparatus 100 into the fluid pump 136. In this regard, the fluid pump 136 in some embodiments includes one or more inlets that draws in fluid from the surrounding utilizing suction. The flow of fluid is directed towards the seat portion 120, as indicated by fluid flow indicator 404. In some embodiments, the fluid collected by the fluid pump 136 is routed as a single flow of fluid. In other embodiments, the fluid collected by the pump 136 is portioned into a plurality of flows of fluid. For example, in some embodiments, the pump 136 directs a first portion of fluid in a first direction (e.g., towards fluid outlets of a back portion of the therapeutic fluid apparatus 100) and directs a second portion of fluid in a second direction (e.g., towards fluid outlets of one or more support(s) of the therapeutic fluid apparatus 100). In this regard, the fluid pump 136 in some embodiments directs collected fluid in accordance with fluid flow indicator 404. In some embodiments, the fluid pump 136 directs a first portion of fluid in accordance with the fluid flow indicator 404 and optionally directs a second portion of fluid in accordance with the fluid flow indicator 406. In some embodiments, the fluid is directed interiorly through the fluid pump 136. Alternatively or additionally, in some embodiments, the fluid pump 136 directs the fluid to one or more support(s) positioned near or otherwise attached to the fluid pump 136.

The flow of fluid proceeds in the direction towards each of the fluid outlets of the therapeutic fluid apparatus 100. For example, as illustrated at least a portion of fluid is directed in accordance with fluid flow indicator 410. The portion of fluid directed in accordance with the fluid flow indicator 410 is piped throughout the back portion 104 of the therapeutic fluid apparatus 100. In some embodiments, at least a portion of fluid is directed via one or more portion(s) of piping towards each of the fluid outlets connected to the back portion of the therapeutic fluid apparatus 100. In this regard, as the fluid reaches each fluid outlet, such a fluid outlet is configured to produce a fluid stream utilizing some or all the fluid that reached the fluid outlet. In some embodiments each fluid outlet is associated with a different portion of piping, for example that branches off at a particular point along the flow of fluid (e.g., where the fluid enters the seat portion and splits between the back portion and the seat portion), or that is directly fluidically coupled only with that fluid outlet from intake at the fluid pump 136.

In addition to the portion of fluid directed in accordance with fluid flow indicator 410, another portion of fluid is directed in accordance with the fluid flow indicator 408. The portion of fluid directed in accordance with the fluid flow indicator 408 is piped throughout the seat portion 120 of the therapeutic fluid apparatus 100. The flow of fluid is then directed in accordance with fluid flow indicator 412 and piped through one or more front support(s) of the therapeutic fluid apparatus 100, for example supports 124a and 124b. In some embodiments, at least a portion of the fluid is directed via one or more portion(s) of piping throughout the seat portion 120 towards each of the fluid outlets fluidically coupled with one or more front support(s) of the therapeutic fluid apparatus 100, for example support 124a and support 124b. In this regard, as the fluid reaches each fluid outlet, such a fluid outlet is configured to produce a fluid stream utilizing some or all of the fluid that reached the fluid outlet. In some embodiments each fluid outlet is associated with a different portion of piping, for example that branches off at a particular point along the flow of fluid (e.g., where the fluid enters the seat portion and splits between the back portion and the seat portion), or that is directly fluidically coupled only with that fluid outlet from intake at the fluid pump 136.

Some, all, or no portion of the fluid streams produced by the fluid outlets subsequently may make contact with a user. In this regard, fluid runoff from the user and/or therapeutic fluid apparatus 100, and/or fluid that fails to make contact with the user or therapeutic fluid apparatus 100 at all, is reintroduced to the environment surrounding the therapeutic fluid apparatus 100. In this regard, the same fluid may be recirculated as collected by the fluid pump 136 during a subsequent flow of fluid.

In some other embodiments, the fluid pump 136 directs fluid through other component(s) and/or path(s) throughout the therapeutic fluid apparatus 100. For example, in some embodiments, the fluid pump 136 directs fluid through one or more back support(s), such as the supports 124a and 124b. Additionally or alternatively, in some embodiments, a single support embodies a front support and a back support (e.g., curved to bridge from the front to the back of the therapeutic fluid apparatus 100), and fluid is directed continuously through the support to reach the fluid outlet(s) in the portion embodying the front support without requiring piping through the remainder of the therapeutic fluid apparatus 100. Alternatively or additionally still, in some embodiments, piping is provided on the sides of one or more portion(s) of the therapeutic fluid apparatus 100 to avoid directing fluid through the internal space of such portion(s).

In some embodiments, the therapeutic fluid apparatus 100 is configured to receive one or more additional portions that include additional fluid outlets. In some embodiments, the additional portions are intended to direct fluid streams from to other parts of the user's body that may not be impacted by fluid streams produced by the fluid outlets 114, fluid outlets 116, fluid outlets 118, fluid outlets 128, and/or fluid outlets 130. In some embodiments, each additional portion is attachable to the therapeutic fluid apparatus 100 to configure the therapeutic fluid apparatus 100 for such extended capabilities. In this regard, the additional portion may in some embodiments similarly be removed from the therapeutic fluid apparatus 100. Alternatively or additionally, in some embodiments the therapeutic fluid apparatus 100 is constructed with such additional portion(s) integrated

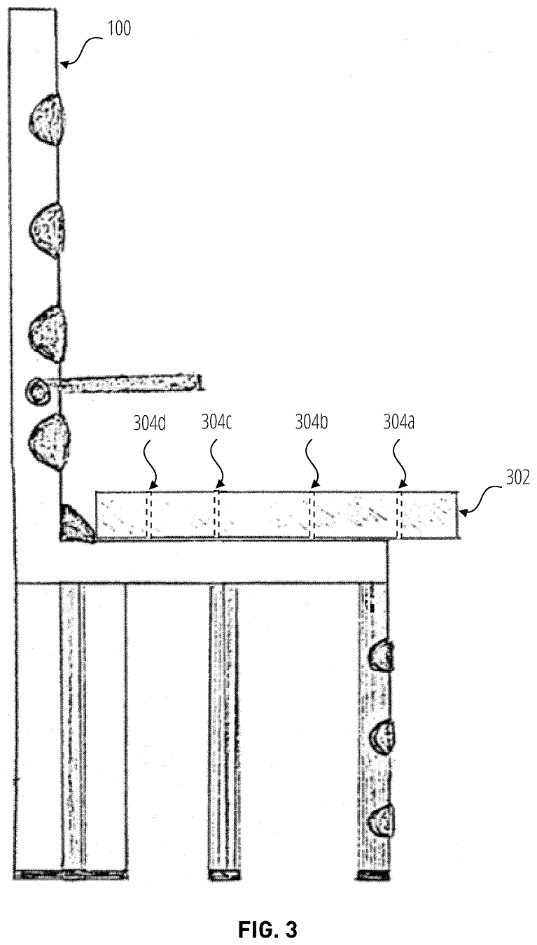

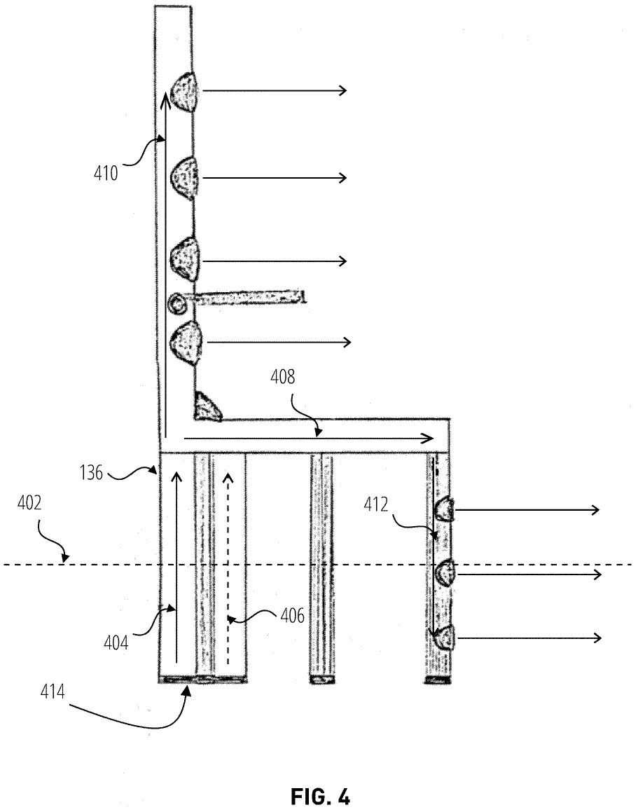

For example, FIG. 5 illustrates a side orthogonal view of an example therapeutic fluid apparatus with a head portion in accordance with at least some example embodiments of the present disclosure. Specifically, FIG. 5 depicts a head portion 502 and fluid flow indicators associated therewith. FIG. 6 illustrates a front orthographic view of a head portion of a therapeutic fluid apparatus in accordance with at least some example embodiments of the present disclosure, specifically the head portion 502 and fluid flow indicators associated therewith.

The head portion 502 includes one or more fluid outlet(s) 508. In some embodiments, each fluid outlet of the head portion 502 produces a fluid stream as described herein with respect to the other fluid outlets of the therapeutic fluid apparatus 100. In this regard, the fluid outlet(s) 508 in some embodiments are oriented downwards (e.g., below a horizontal axis) to direct a flow of liquid towards a user's head and/or shoulders, for example in accordance with the fluid flow indicator 506. As depicted, for example, in some embodiments the fluid outlet(s) 508 embody or include a single fluid outlet that extends substantially along the length of the head portion 502. Alternatively or additionally, in some embodiments, the fluid outlet(s) 508 embody or include a plurality of fluid outlets that are located at one or more positions along the length of the head portion 502.

As illustrated, the head portion 502 is connected to the back portion 104 of the therapeutic fluid apparatus 100. Specifically, the head portion 502 is connected to the back portion 104 at a connection point 504 located at the top of the back portion 104. In some embodiments, the head portion 502 is slotted into place, and/or secured utilizing one or more securing mechanisms as described herein, to attach the head portion 502 to the back portion 104 at the connection point 504. Once connected, in some embodiments one or more portions of piping internal to the head portion 502 is fluidically coupled with piping of the back portion 104 and/or fluid pump 136 to enable directing of fluid up through the head portion 502. Specifically, at least a portion of fluid is directed up the head portion 502 in accordance with the fluid flow indicator 510.

In some embodiments, at least a portion of the fluid directed in accordance with the fluid flow indicator 510 is piped throughout the head portion 502. In some embodiments, at least a portion of the fluid is directed via one or more portion(s) of piping towards each fluid outlet of the fluid outlet(s) 508 connected to the head portion 502. In this regard, as the fluid reaches each fluid outlet, such a fluid outlet is configured to produce a fluid stream utilizing some or all the fluid that reached the fluid outlet. In some embodiments each fluid outlet is associated with a different portion of piping, for example that branches off at a particular point along the flow of fluid (e.g., where the fluid enters the seat portion and splits between the back portion and the seat portion), or that is directly fluidically coupled only with that fluid outlet from intake at the fluid pump 136.

Additionally or alternatively, in some embodiments the therapeutic fluid apparatus 100 includes one or more shoulder portion(s). In some embodiments, the shoulder portion(s) is/are configured to produce fluid stream(s) directed towards the user's shoulder(s) and/or arm(s). In this regard, the shoulder portion(s) may embody and/or include a wing that attaches to a side of the back portion and/or seat portion, and include fluid outlet(s) directed inward towards the center of the seat portion 120. It will be appreciated that the shoulder portion(s) in some embodiments each produce a fluid stream as described herein with respect to the other fluid outlets of the therapeutic fluid apparatus 100 and/or head portion 502. In some embodiments, each shoulder portion is connected to the therapeutic fluid apparatus 100, for example connected to a side of the back portion 104 and/or to a side of the seat portion 120. In some such embodiments, the shoulder portion is attachable by connecting, slotting into place, and/or otherwise securing utilizing one or more securing mechanisms as described herein, the shoulder portion to the therapeutic fluid apparatus 100. Once attached, in some embodiments one or more portions of piping internal to the shoulder portion is fluidically coupled with piping of the therapeutic fluid apparatus 100 (e.g., in the back portion 104, in the seat portion, and/or of the fluid pump 136) to enable directing of fluid through the side portion and out one or more fluid outlet of the shoulder portion. In some embodiments, the therapeutic fluid apparatus 100 includes a shoulder portion associated with each of the left side of the therapeutic fluid apparatus 100 and the right side of the therapeutic fluid apparatus 100 to make contact with each shoulder of a user.

In some embodiments, one or more fluid outlet(s) of the shoulder portion(s) is/are not pressurized. In this regard, such fluid outlet(s) may produce a stream of fluid intended to make contact with the user with less force. In some embodiments, such fluid stream(s) is/are utilized to direct fluid at the user to ensure the user remains warm or otherwise continually coated with the fluid.

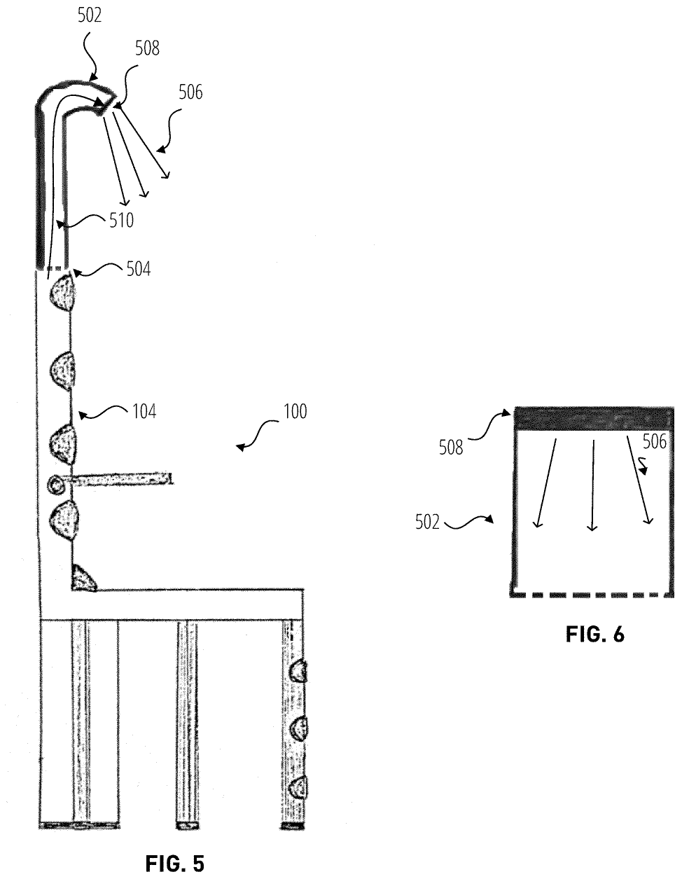

FIG. 7 illustrates a side orthographic view of an example therapeutic fluid apparatus with a separate foot therapeutic apparatus in accordance with at least some example embodiments of the present disclosure. Specifically, FIG. 7 depicts an example foot therapeutic apparatus 704. It will be appreciated that the user's feet may be blocked (e.g., by the user's legs) in circumstances where the user is seated upon the therapeutic fluid apparatus 100. In this regard, the fluid streams generated by the fluid outlets of the therapeutic fluid apparatus 100 may not directly make contact with the user's feet. The foot therapeutic apparatus provides separate fluid stream(s) for impacting the user's feet.

The foot therapeutic apparatus 704 in some embodiments attaches with the therapeutic fluid apparatus 100. For example, as illustrated, the foot therapeutic apparatus 704 is attached to the therapeutic fluid apparatus 100 at the connection point 702. In some embodiments, the foot therapeutic apparatus 704 is connected to one or more of the support(s) of the therapeutic fluid apparatus 100, for example the front support 124a and/or front support 124b. In some embodiments, the foot therapeutic apparatus 704 is slotted into place, and/or secured utilizing one or more securing mechanisms as described herein, to attach the foot therapeutic apparatus 704 at the connection point 702. Additionally or alternatively, in some embodiments, the foot therapeutic apparatus 704 is permanently molded to or otherwise affixed (e.g., via welding) to the remainder of the therapeutic fluid apparatus 100.

In some embodiments, once connected one or more portion(s) of piping internal to the foot therapeutic apparatus 704 is fluidically coupled with piping of the support(s) 124a and/or 124b, and/or of the fluid pump 136, to enable directing of fluid to the foot therapeutic apparatus 704. Specifically, at least a portion of fluid is directed into the foot therapeutic apparatus 704 in accordance with the fluid flow indicator 708.

In some embodiments, the portion of fluid that flows into the 704 is utilized to produce one or more fluid stream(s) within the foot therapeutic apparatus 704. Additionally or alternatively, in some embodiments, the fluid that flows into the foot therapeutic apparatus 704 fills an internal volume of the foot therapeutic apparatus 704. Additionally or alternatively, in some embodiments, the foot therapeutic apparatus 704 includes a vibrating mat. The vibrating mat may make contact with the bottom of the user's feet while the user has placed their feet in the foot therapeutic apparatus 704. In some embodiments, the vibrating mat is powered by a battery or other external power source associated solely with the foot therapeutic apparatus 704. Alternatively or additionally, in some embodiments, the vibrating mat receives power from the fluid pump 136 of the therapeutic fluid apparatus 100, for example via wiring from a battery thereof.

Example Environments and Uses of Apparatuses of the Disclosure

Having described example apparatuses and operation of such apparatuses of the disclosure, example environments and uses of the apparatuses will now be discussed. It will be appreciated that the example environments and use cases described are exemplary and meant to provide a non-limiting context and visualization of operation of the apparatuses described herein. Accordingly, the specific environments should not limit the scope and spirit of this disclosure or the coverage of the claims appended herein.

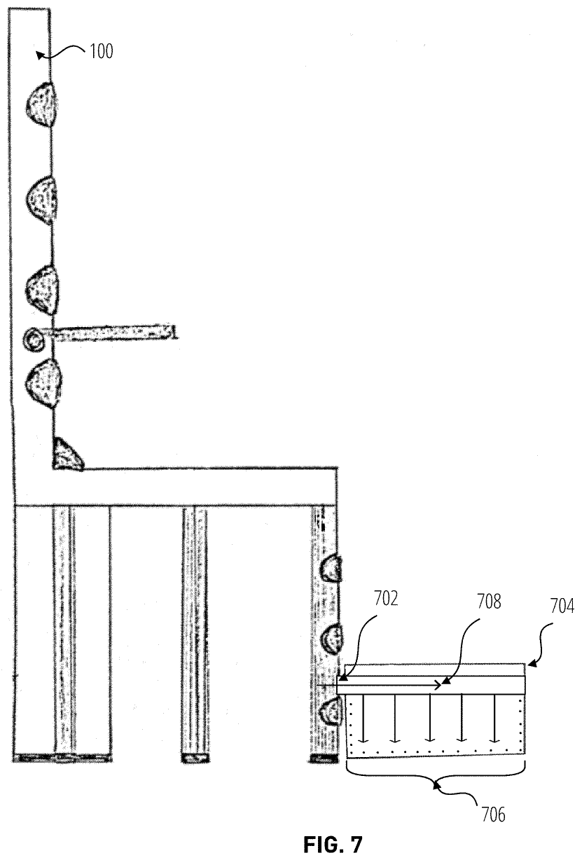

FIG. 8 illustrates an example therapeutic fluid apparatus directing fluid from an example environment in accordance with at least some example embodiments of the present disclosure. Specifically, FIG. 8 depicts the therapeutic fluid apparatus 100 operating in a first environment defined by a tub 802. In some embodiments, the tub 802 embodies or includes a bath tub located within a user's bathroom. In other embodiments, the tub 802 embodies or includes any other fluid-holding vessel of a sufficient depth. For example, in some embodiments the tub 802 embodies a basin, a fixed pool, a moveable pool, an inflatable pool, and/or the like.

The tub 802 is filled with a fluid 804. In some embodiments, the fluid 804 is filled up to a minimum fluid height associated with the tub 802 to enable a continuous flow of the liquid 804. In some embodiments, the fluid 804 embodies or includes water to be sprayed at, over, and/or otherwise on a user seated upon the therapeutic fluid apparatus 100. In some embodiments, the user utilizes an external fill mechanism to fill the tub 802 with said water. For example, in the example context of a bath tub, the tub 802 may be filled utilizing a spout and/or plumbing mechanisms conventionally utilized to fill a bath tub. Alternatively or additionally, the tub 802 may be filled via a hose, transportation of water (or another liquid) via one or more container(s), bucket(s), and/or the like.

Upon activation of the therapeutic fluid apparatus 100 (e.g., by a user manually engaging a toggle of the therapeutic fluid apparatus 100 to initiate operation), the therapeutic fluid apparatus 100 begins to draw the fluid 804 from the tub 802 and produce fluid streams via the fluid outlets of the therapeutic fluid apparatus 100. Returning to the example context of water as the fluid 804, water may be drawn from the tub 802 and sprayed via water streams produced by the fluid outlets of the therapeutic fluid apparatus 100. At least some of the fluid streams may make contact with the user's body while the user is positioned upon the therapeutic fluid apparatus 100 (e.g., seated upon the seating seat portion 120). As the fluid streams are produced, all or at least a portion of said fluid is then directly reintroduced into the environment, ran off of the therapeutic fluid apparatus 100 itself, and/or ran off of the user positioned upon the therapeutic fluid apparatus 100. In this regard, such fluid is not wasted, and instead is reintroduced into the fluid 804 for further user, enabling recirculation of water during operation of the therapeutic fluid apparatus 100. In this regard, the user may never need to refill the fluid 804, or may do so only after a significantly long period of time has passed such that the user's body and/or the environment has absorbed some of the fluid 804.

By using the fluid 804 in the tub 802, the user may separately control one or more aspects of the fluid 804. For example, the user may introduce external elements to alter the temperature of the fluid 804, such as by introducing ice to cool the fluid 804 and/or a heated element to heat the fluid 804. The user may alter the temperature of the fluid 804 to a temperature of their liking before and/or during operation of the therapeutic fluid apparatus 100. Alternatively or additionally, the user may introduce additional fluid to alter the temperature of the fluid 804, such as by filling the tub 802 with additional colder or hotter fluid than the existing fluid 804 within the tub 802. In this regard, the user is provided control over characteristics of the fluid 804 utilized by the therapeutic fluid apparatus 100 without requiring additional control(s), alteration to the existing control(s) in a particular environment, and/or additional specialized knowledge by the user. For example, in the context where the tub 802 embodies or includes a bathtub accompanied by plumbing controls for hot and cold water that the user is familiar with, the user may utilize such controls to fill the tub and/or alter the temperature of the fluid 804 before and/or during operation without any such changes to the environment or additional user knowledge.

In some embodiments, the therapeutic fluid apparatus 100 is moveable during operation. For example, a user may lift the therapeutic fluid apparatus 100 and relocate it to another position within the tub 802. Alternatively, in some embodiments, a user may slide the therapeutic fluid apparatus 100 to a preferred position. It will be appreciated that the user may desire to move the therapeutic fluid apparatus 100 for any of a myriad of reasons, for example to change their field of view, to be seated in a preferred area, to reorient the therapeutic fluid apparatus 100 to minimize fluid escaping the environment, and/or the like.

In some contexts, an environment may not be sufficiently enclosed to enable operation of the therapeutic fluid apparatus 100. In some such contexts, at least a portion of a boundary defining the environment is not sufficiently high to satisfy a minimum fluid height. Nevertheless, a user may desire to utilize the particular environment for operation of the therapeutic fluid apparatus 100, for example because the environment is waterproof or otherwise safe for exposure to fluids without damaging the environment. One such example context includes a shower in a bathroom, where the boundary of the shower includes one side of a boundary defining the shower that is below the minimum fluid height. The user may desire to utilize the therapeutic fluid apparatus 100 within an environment defined by the boundary of the shower to avoid having water damage other portion(s) of their bathroom.

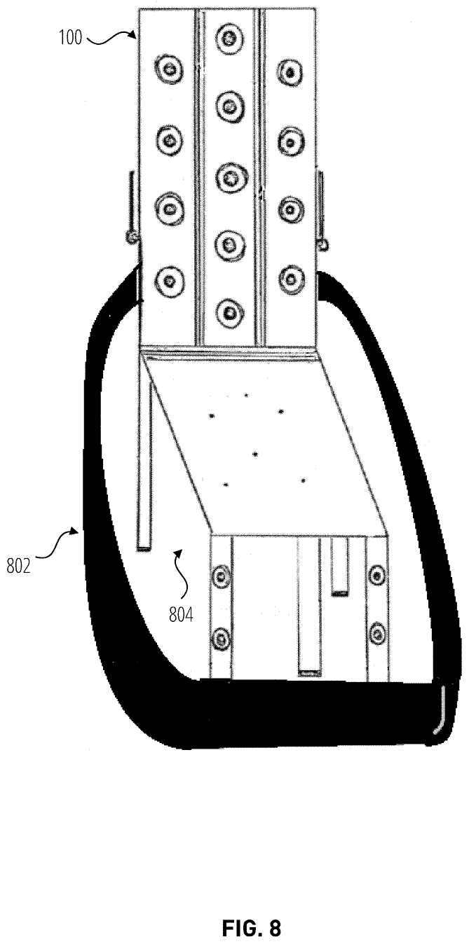

FIG. 9 illustrates an example therapeutic fluid apparatus directing fluid from an example environment in accordance with at least some other example embodiments of the present disclosure. Specifically, FIG. 9 depicts a shower environment 900 modified with a boundary material 902 and within which a therapeutic fluid apparatus 100 operates. In this regard, the boundary material 902 is utilized to increase the height of at least a portion of the boundary defining the environment 900. The boundary material 902 may be removably secured along the portion of the boundary to increase the height along that portion of the boundary to above a minimum fluid height. As illustrated, the boundary material 902 enables the user to fill the environment 900 around the therapeutic fluid apparatus 100 with fluid 906, enabling the therapeutic fluid apparatus 100 to direct fluid from the environment 900 for use. In this regard, once the environment 900 is filled with the fluid 906, the therapeutic fluid apparatus 100 may be activated to operate in a manner similarly or identical to that described with respect to FIG. 8.

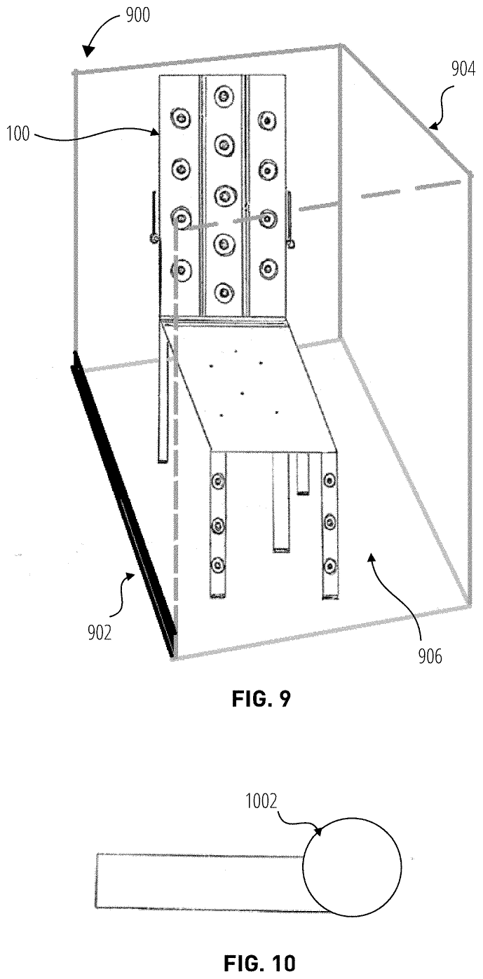

In some embodiments, the boundary material 902 embodies a waterproof material. In this regard, the boundary material 902 may be any material configured to prevent particular liquids (e.g., water) or all liquids from damaging or eroding the boundary material 902. Additionally or alternatively, in some embodiments the boundary material 902 is sufficiently rigid such that it maintains its height when placed in the environment. In some embodiments, the boundary material 902 is rigid such that it does not significantly bend, fold, or otherwise reshape in any direction. In some embodiments, the boundary material 902 is flexible in one or more directions, such that the boundary material may be reshaped along that direction (e.g., to match the shape of the boundary of the environment). Non-limiting examples of a flexible boundary material is depicted and described with respect to FIG. 10.

In some embodiments, the boundary material 902 includes or otherwise is secured utilizing an adhesive applied to at least one side of the boundary material 902. As illustrated in FIG. 9, the boundary material 902 may include an adhesive applied to the side of the boundary material 902, such that the adhesive enables the boundary material to form a fluid-resistant or fluid-proof seal with the floor of the environment 900 to which it is secured. Additionally or alternatively, in some embodiments the boundary material 902 includes an adhesive applied to the sides of the boundary material 902, such that the adhesive enables the boundary material to form a fluid-resistant or fluid-proof seal with the walls of the environment 900 to which it is secured. In this regard, the height of the boundary defining the environment 900 may be increased, enabling the fluid 906 to pool to a higher height without significant risk of leaking outside of the environment 900. In some embodiments, the adhesive embodies a water-tight glue, caulk, and/or the like. The boundary material 902 may utilize any waterproof or otherwise fluid-proof or resistant adhesive known in the art.

In some embodiments, a therapeutic fluid apparatus is built at least in part into the environment. For example, in some embodiments, the seat portion of the therapeutic fluid apparatus 100 folds out from a wall or other side portion of the environment, such as the environment 900. Additionally or alternatively, in some embodiments, one or more fluid outlet(s) is built into, or connected at least in part to, a wall or side portion of the environment. In some such embodiments, the therapeutic fluid apparatus is not removable from the environment.

In some embodiments, the boundary material is sufficiently flexible along its length to enable the material to be rolled. FIG. 10 illustrates an example roll of flexible border material usable to enclose a particular environment boundary to a minimum fluid height in accordance with at least some example embodiments of the present disclosure. In this regard, the flexible boundary roll 1002 may be unrolled to the appropriate length to be applied along a particular portion of a border of a boundary. Additionally or alternatively, a portion of the flexible boundary roll 1002 may be removed and shaped or otherwise manipulated to match the curvature of the boundary to which it is to be applied. In this regard, in some such embodiments, the boundary material need not be applied specifically in a straight line, and may be manipulated to define the existing boundary curvature and/or shape for the environment. In some embodiments, the flexible boundary roll 1002 embodies a boundary material including or embodying a rubber or composite rubber roll, which enables cutting of the flexible boundary roll 1002 to any desired length.

Example Methods of the Disclosure

Having described example apparatuses and operation of such apparatuses, as well as example environments and uses of the apparatuses of the disclosure, example methods in accordance with the disclosure will now be discussed. Each of the methods is depicted as a flowchart including one or more operational blocks. It will be appreciated that each of the flowcharts depicts a process performable by various means, including one or more of the apparatus(es) described herein and/or users interacting with said apparatus(es), such as the therapeutic fluid apparatus 100.

Each block of the processes, and combinations of blocks in the flowcharts, may be performed by the therapeutic fluid apparatus 100 and/or user(s) interacting with the therapeutic fluid apparatus 100. Each of the processes depicts operational block(s) that each define a particular portion of a method of using the apparatus(es) described herein, such as the therapeutic fluid apparatus 100. The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

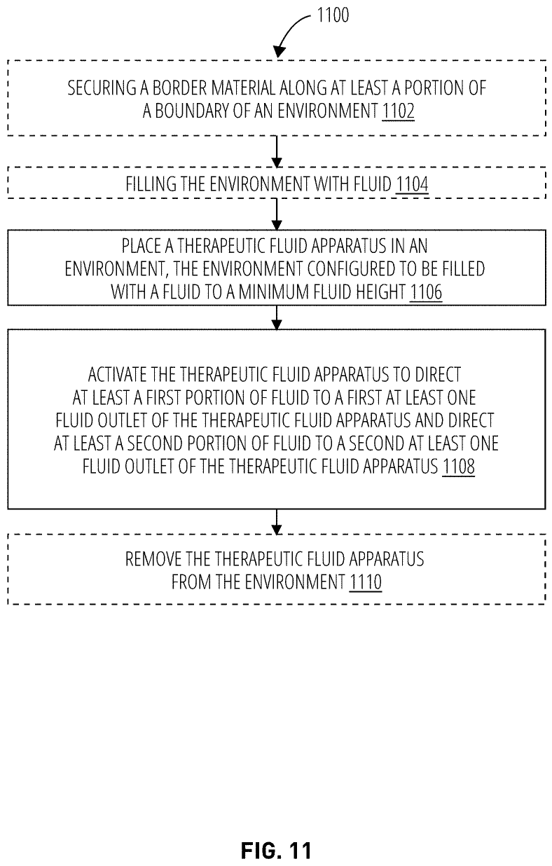

FIG. 11 illustrates a method of utilizing a therapeutic fluid apparatus for fluid therapy in accordance with at least some embodiments of the present disclosure. Specifically, FIG. 11 depicts an example method 1100. The method 1100 in some embodiments is performed by a user interacting with the therapeutic fluid apparatus 100 within a particular environment.

At optional block 1102, the method includes securing a border material along at least a portion of a boundary of an environment. In some embodiments, the border material is secured to form a fluid-tight seal along the portion of the boundary of the environment. In some embodiments, the boundary material increases the height of the portion of the boundary by a thickness of the boundary material in a first direction (e.g., embodying a height of the boundary material). In this regard, the border material may increase the height of the portion of the boundary to satisfy a minimum fluid height for operation of a therapeutic fluid apparatus.

At optional block 1104, the method includes filling an environment with fluid. In some embodiments, a user fills the environment utilizing plumbing mechanism(s) and/or other existing physical structure(s) in the environment, such as one or more spout(s) within the environment. Alternatively or additionally, in some embodiments the user fills the environment with a fluid utilizing one or more manual means. For example, in some embodiments a user fills the environment utilizing a hose, bucket(s), and/or other means for transporting fluid to the environment from another location.

At block 1106, the method includes placing a therapeutic fluid apparatus in an environment. In some embodiments, the environment is configured to be filled with a fluid to a minimum fluid height. The environment may be previously configured utilizing existing structure of the environment (e.g., existing walls and/or other boundaries of sufficient height), or configured utilizing a boundary material as described with respect to optional operation 1102. In some embodiments, a user may carry the therapeutic fluid apparatus, such as the therapeutic fluid apparatus 100, to the environment and place it within the environment. Alternatively or additionally, in some embodiments, the therapeutic fluid apparatus is already placed within the environment.

At block 1108, the method includes activating the therapeutic fluid apparatus to being operation. During operation, the therapeutic fluid apparatus directs at least a first portion of fluid to a first at least one fluid outlet of the therapeutic fluid apparatus, and directs at least a second portion of fluid to a second at least one fluid outlet of the therapeutic fluid apparatus. Each of the fluid outlets produces a fluid stream utilizing all or at least some of the fluid that is directed to said fluid outlet. During and/or before the method, in some embodiments a user is positioned upon the therapeutic fluid apparatus. In this regard, the therapeutic fluid apparatus produces one or more, or a plurality, of fluid streams that make contact with the user's body. As the fluid is reintroduced into the environment (e.g., by being sprayed back into the environment directly from a fluid outlet or runoff from a user or the therapeutic fluid apparatus), such fluid is recirculated by the therapeutic fluid apparatus for further use.

At optional block 1110, the method includes removing the therapeutic fluid apparatus from the environment. In some embodiments, a user lifts the therapeutic fluid apparatus to carry it out from the environment. Additionally or alternatively, in some embodiments, the method includes removing a border material utilized to secure the environment. In this regard, the environment returns to its original state without damage and/or permanent alteration to the environment.

Many modifications and other embodiments of the present inventions set forth herein will come to mind to one skilled in the art to which these inventions pertain having the benefit of the teachings presented in the foregoing descriptions and the associated drawings. Therefore, it is to be understood that the present inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A therapeutic fluid apparatus comprising:
a back portion and a seat portion,
wherein the back portion comprises a first at least one fluid outlet;
at least one support connected to the seat portion, the at least one support comprising a second at least one fluid outlet;
at least one fluid pump fluidically coupled to the first at least one fluid outlet and the second at least one fluid outlet, wherein the at least one fluid pump is configured to direct at least a first portion of fluid to the first at least one fluid outlet and at least a second portion of fluid to the second at least one fluid outlets.

2. The therapeutic fluid apparatus of claim 1, wherein the fluid pump comprises a battery configured to power to the fluid pump.

3. The therapeutic fluid apparatus of claim 1, wherein the fluid pump comprises a toggle configured to activate the fluid pump.

4. The therapeutic fluid apparatus of claim 1, wherein the back portion comprises at least a first spacer and a second spacer.

5. The therapeutic fluid apparatus of claim 1, the therapeutic fluid apparatus further comprising a horizontal spacer connected to the back portion at a point where the back portion contacts the seat portion.

6. The therapeutic fluid apparatus of claim 1, wherein the first at least one fluid outlet comprises a first plurality of fluid outlets.

7. The therapeutic fluid apparatus of claim 6, wherein the back portion comprises at least one spacer that separates a first section of the back portion and a second section of the back portion, and wherein the first plurality of fluid outlets comprises at least a first fluid outlet connected to the first section of the back portion and at least a second fluid outlet connected to the second section of the back portion.

8. The therapeutic fluid apparatus of claim 1, wherein the at least one support comprises a plurality of supports.

9. The therapeutic fluid apparatus of claim 8, wherein the plurality of supports comprises at least one rear support and at least one front support, wherein the at least one front support comprises the first second at least one fluid outlet.

10. The therapeutic fluid apparatus of claim 9, wherein the plurality of supports comprises at least one support connected to the seat portion between the at least one front support and the at least one rear support.

11. The therapeutic fluid apparatus of claim 8, wherein the plurality of supports comprises at least a front left support and a front right support, wherein the front left support comprises a first portion of the second at least one fluid outlets and wherein the front right support comprises a second portion of the second at least one fluid outlets.

12. The therapeutic fluid apparatus of claim 11, wherein the front left support connected to the seat portion at a front left corner of the seat portion, and wherein the front right support is connected to the seat portion at a front right corner of the seat portion.

13. The therapeutic fluid apparatus of claim 1, the therapeutic fluid apparatus further comprising a pressure control configured to control a pressure of fluid output by each of the first at least one fluid outlet and each of the second at least one fluid outlet.

14. The therapeutic fluid apparatus of claim 1, wherein at least a first fluid outlet of the first at least one fluid outlet and/or the second at least one fluid outlet comprises a pressure control configured to control a pressure of fluid output by the first fluid outlet.

15. The therapeutic fluid apparatus of claim 1, the therapeutic fluid apparatus further comprising at least one pipe connecting the fluid pump to the first at least one fluid outlet and the second at least one fluid outlet.

16. The therapeutic fluid apparatus of claim 1, the therapeutic fluid apparatus further comprising a head portion connected to a top of the back portion, the head portion comprising a third at least one fluid outlet oriented towards the seat portion.

17. The therapeutic fluid apparatus of claim 1, the therapeutic fluid apparatus further comprising a left shoulder portion connected to a left side of the back portion, and a right shoulder portion connected to a right side of the back portion, wherein the left shoulder portion comprises a third at least one fluid outlet, and wherein the right shoulder portion comprises a fourth at least one fluid outlet.

18. A method of utilizing a therapeutic fluid apparatus for fluid therapy comprising:
placing a therapeutic fluid apparatus in an environment, the environment configured to be filled with a fluid to a minimum fluid height;
activating the therapeutic fluid apparatus to direct at least a first portion of fluid to a first at least one fluid outlet of the therapeutic fluid apparatus and direct at least a second portion of fluid to a second at least one fluid outlet of the therapeutic fluid apparatus; and
removing the therapeutic fluid apparatus from the environment.

19. The method of claim 18, the method further comprising securing a flexible border material along at least a portion of a boundary of the environment, wherein the flexible border material increases a height at the portion of the boundary to exceed the minimum fluid height before the environment is filled with the fluid.

20. The method of claim 18, the method further comprising filling the environment with the fluid.
